(19) United States
(12) Patent Application Publication
(10) Pub. No.: US 2026/0311139 A1
(43) Pub. Date: Oct. 8, 2026

(54) METHOD OF REPAIRING A HEARING AID AND A HEARING AID REPAIR SYSTEM

(71) Applicant: WS Audiology A/S, Lynge (DK)

(72) Inventors: Dorte Britt LARSEN, Lynge (DK); Stefan SCHMITZ, Herlev (DK)

(73) Assignee: WS Audiology A/S, Lynge (DK)

(21) Appl. No.: 19/482,808

(22) PCT Filed: May 15, 2024
(86) PCT No.: PCT/EP2024/063455

§ 371 Date: Nov. 10, 2025

(30) Foreign Application Priority Data
May 15, 2023 (DK) PA202330027

(51) Int. Cl. G06Q 10/20; G06Q 10/083; H04R 25/00

(52) U.S. Cl. CPC G06Q 10/20; G06Q 10/083; H04R 25/305; H04R 2225/55

(57) ABSTRACT

A method (100) of repairing a hearing aid and a hearing aid repair system.

The present invention relates to a method of repairing a hearing aid. The present invention also relates to a hearing aid repair system adapted to carry out said method.

### BACKGROUND OF THE INVENTION

Generally a hearing aid according to the invention is understood as meaning any device which provides an output signal that can be perceived as an acoustic signal by a user or contributes to providing such an output signal, and which has means which are customized to compensate for an individual hearing loss of the user or contribute to compensating for the hearing loss of the user. They are, in particular, hearing aids which can be worn on the body or by the ear, in particular on or in the ear, and which can be fully or partially implanted.

Within the present context a traditional hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, resulting in a so-called audiogram, of the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor, and an acoustic output transducer. The signal processor is preferably a digital signal processor. The hearing aid is enclosed in a casing suitable for fitting behind or in a human ear.

Within the present context a hearing aid system may comprise a single hearing aid (a so called monaural hearing aid system) or comprise two hearing aids, one for each ear of the hearing aid user (a so called binaural hearing aid system). Furthermore, the hearing aid system may comprise an external device, such as a smart phone having software applications adapted to interact with other devices of the hearing aid system. Thus within the present context the term “hearing aid system device” may denote a hearing aid or an external device.

The mechanical design of hearing aids has developed into a number of general categories. As the name suggests, Behind-The-Ear (BTE) hearing aids are worn behind the ear. To be more precise, an electronics unit comprising a housing containing the major electronics parts thereof is worn behind the ear. An earpiece for emitting sound to the hearing aid user is worn in the ear, e.g. in the concha or the ear canal. In a traditional BTE hearing aid, a sound tube is used to convey sound from the output transducer, which in hearing aid terminology is normally referred to as the receiver, located in the housing of the electronics unit and to the ear canal. In some modern types of hearing aids, a conducting member comprising electrical conductors conveys an electric signal from the housing and to a receiver placed in the earpiece in the ear. Such hearing aids are commonly referred to as Receiver-In-The-Ear (RITE) hearing aids. In a specific type of RITE hearing aids the receiver is placed inside the ear canal. This category is sometimes referred to as Receiver-In-Canal (RIC) hearing aids.

In-The-Ear (ITE) hearing aids are designed for arrangement in the ear, normally in the funnel-shaped outer part of the ear canal. In a specific type of ITE hearing aids the hearing aid is placed substantially inside the ear canal. This category is sometimes referred to as Completely-In-Canal (CIC) hearing aids. This type of hearing aid requires an especially compact design in order to allow it to be arranged in the ear canal, while accommodating the components necessary for operation of the hearing aid.

In WO-2012119639-A1 it is disclosed that hearing devices are usually very reliable. However, sometimes they may degrade or completely stop functioning. In this case, the user of the hearing device usually seeks assistance by a specialist for hearing devices, typically an audiologist. Typically, the audiologist carries out an error diagnostic in order to identify the cause of the problem, for example by visually inspecting the hearing device or by performing acoustical tests. Based on this diagnostic, the audiologist may decide to immediately replace the covering by himself instead of sending the hearing device to a service center.

In U.S. Pat. No. 8,077,889-B2 it is disclosed how data logging is used to gather information regarding the state of a so-called wind and weather protection which is placed over a microphone opening as a sound-transparent cover, because if such a wind and weather protection gets dirty, the transfer characteristics of the cover will change and as a result thereof, a strong attenuation is formed for the sound in particular for high frequency components. These frequency components do not get into the hearing device at all and therefore also not to the hearing device user. As a result thereof, the comprehensibility of the hearing device user decreases. According to U.S. Pat. No. 8,077,889-B2 a very simple action to improve matters is to exchange the cover used as wind and weather protection by the fitter (or by the hearing device user himself). The cover must be exchanged, dependent on the use of the hearing device, every two to six months by a new cover.

This can be accomplished by the fitter in a simple manner. Unfortunately, the problem of a “dirty cover” is very often not recognized by the fitter, and the hearing device is unnecessarily sent back to the manufacturer for service. This procedure is expensive and causes a waste of service capabilities. In addition, the hearing device user has no hearing device available during this time. According to U.S. Pat. No. 8,077,889-B2 is therefore suggested to monitor the state of the cover internally, and-if need be-to generate a corresponding information or instructions to the hearing device user, respectively (as for example an acoustic message “Please consult your fitter!”). As soon as the fitter connects the hearing device to the fitting software, a corresponding message appears on his monitor, saying, for example, “Please replace the cover!”. With the aid of the hardware data, the fitter can therefore refine his judgment of the hearing device, which gives him the possibility to detect possible hardware damage in a short time.

Thus all the discussed prior art is common in that the hearing aid to be repaired needs to be brought to the audiologist/hearing aid fitter or to a service center or alternatively that the user fixes the issue.

It is therefore a feature of the present invention to provide an improved method of repairing a hearing aid.

It is another feature of the present invention to provide a hearing aid repair system adapted to provide such a method of repairing a hearing aid.

### SUMMARY OF THE INVENTION

The invention, in a first aspect, provides a method of repairing a hearing aid that enables a replacement hearing aid to be manufactured without having access to the malfunctioning hearing aid.

This provides a method of repairing that is very fast and hereby minimizes the time a hearing aid user needs to be without the malfunctioning hearing aid.

The invention, in a second aspect, provides a hearing aid repair system configured to enable malfunctioning or defect hearing aids to be replaced without having access to the malfunctioning or defect hearing aid.

Further advantageous features appear from the dependent claims.

Still other features of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other embodiments, and its several details are capable of modification in various, obvious aspects all without departing from the invention. Accordingly, the drawings and descriptions will be regarded as illustrative in nature and not as restrictive. In the drawings:

FIG. 1 illustrates highly schematically a method of repairing a hearing aid according to an embodiment of the invention.

### DETAILED DESCRIPTION

In the present context the term “at the hearing aid user's discretion” is interpreted to mean that the hearing aid user has given permission to something. More specifically this can be construed to mean that the hearing aid user interacts with a smartphone “app” or some other device that enables the user to consent to something (such as uploading a complete data image of the current hearing aid setting, thus including subsequent user fine tunings that was not part of the initial hearing aid fitting).

In the present context the terminology “said data set is associated with a specific hearing aid user” is interpreted to mean that the data set comprises personal data relating to and/or belonging to the specific hearing aid user.

In the present context the terms “specific hearing aid user” and “hearing aid user” are generally exchangeable. The main purpose of sometimes using “specific hearing aid user” is to improve readability and clarity with respect to being able to distinguish between the plurality of hearing aid users that each are associated with the plurality of data sets comprised in a cloud-based database service and a specific hearing aid user from said plurality of hearing aid users.

In the present context the term “cloud-based database service” covers various database offerings in the cloud and consequently encompasses both cloud-based databases and other data storage solutions such as data warehouses, object storage, data lakes etc.

In the present context the phrases “storing data in” or “uploading data to” (e.g. said “cloud-based database service”) may be used interchangeably.

In the present context the terms “complete data image” and “complete data image of a hearing aid setting” are exchangeable. The shorter version is used to improve readability of the disclosure.

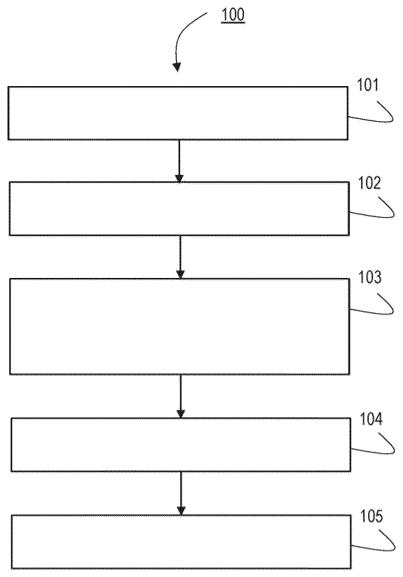

In the present context “a hearing aid repair facility” is, in order to improve readability, somewhere described as having human like capabilities, which obviously not is true in a very strict sense. As one example the feature of “granting said hearing aid repair facility access to at least a part of a specific hearing aid user's data set” is to be construed as granting such an access to people representing said hearing aid repair facility. Reference is now given to FIG. 1, which illustrates highly schematically a method 100 of repairing a hearing aid.

According to a first step 101 of the method, a plurality of data sets, each comprising a complete data image of a hearing aid setting, are stored in a cloud-based database service. Each of said data sets is associated with a specific hearing aid user (i.e. each of said plurality of data sets only contains data related to such a specific hearing aid user thus data belonging to one hearing aid user is only comprised in one data set).

Each of said data sets comprises a complete data image of a hearing aid for said specific hearing aid user. The complete data image contains all the data required to program a novel or refurbished hearing aid to become a replica of the hearing aid that originally contained the data of the complete data image. It is noted that the data set may comprise two complete data images, e.g. one for each ear of the specific hearing aid user. However, the data set may even comprise more than two complete data images, if it is desired to keep the information related to hearing aids previously worn by the hearing aid user, despite that in most situations these older complete data images will not be relevant for the present specific method of repairing a hearing aid.

According to an embodiment said step of storing in a cloud-based database service, for each of a plurality of hearing aid users, a data set comprising a complete data image of a hearing aid setting is carried out as part of the initial hearing aid fitting.

However, alternatively this is carried out at some point in time after the initial hearing aid fitting at the hearing aid user's discretion.

According to an embodiment the complete data image is regularly updated to include subsequent fine-tunings carried out by the user or suggested by a hearing aid care professional or suggested by some automatic system capable of suggesting improvements based on data such as the hearing aid users most visited sound environments, the users typical intention in a given sound environment, the users specific hearing loss, the users mother tongue, the users age, how experienced the user is with respect to wearing hearing aids etc.

According to an embodiment the complete data image is only updated regularly based on the hearing aid user's discretion.

According to an embodiment the regular update of the complete data image is carried out based on a software application (an “app”) on a smart phone.

The regular update may be carried out with a predetermined periodicity or may be in response to a fine tuning change accepted by the hearing aid user, i.e. at the hearing aid user's discretion.

It is a specific advantage of the present invention that the (subsequent) fine-tunings carried out by the hearing aid user are included in the complete data image, whereby the user avoids spending time repeating the fine-tunings when receiving a replacement hearing aid.

According to an embodiment the complete data image comprises the specific hearing aid firmware. Thus according to this embodiment different parts of the complete data image (for a specific user) is stored in the cloud-based database service in different ways because said cloud-based database service only needs to hold one copy of each of the available firmware versions of which there typically are a few though because firmware updates generally are updated (i.e. pushed using e.g. a smartphone as gateway) with regular intervals or in response to a specific need and because different hearing aids may require different firmware's. However, the complete data image for each specific hearing aid user, only needs to contain an identification of or a link to the most recent firmware version uploaded to the hearing aid of the specific hearing aid user, because many (specific) hearing aids users will have the same firmware in their hearing aids. Thus as opposed to how the remaining parts of the complete data image of the hearing aid setting (that is unique for each specific hearing aid user) is stored in the cloud-based database service, then the firmware need not be stored in the complete data image for each specific hearing aid user.

It is a specific advantage of the present invention that by including information about the most recently updated firmware in the complete data image for the specific hearing aid user it can be secured that a binaural hearing aid system will continue to be able to function even after one of the two hearing aids have been replaced, which will only be possible when the two hearing aids of a binaural hearing aid system have the firmware installed.

Additionally, according to an embodiment, each of said data sets comprises personal hearing aid user information including name and residence address or mailing address of said hearing aid user (i.e. the address of a person or business to which mail is delivered, as distinct from the residence address, where said hearing aid user is living). According to an embodiment, the personal hearing aid user information comprises at least one of: the age of the hearing aid user, the sex of the hearing aid user, hearing aid types worn by the hearing aid user, when and for how long each of said worn hearing aids has been worn, repair history for at least one of said worn hearing aids and results of hearing aid performance tests for at least one of said worn hearing aids.

It is noted that not all hearing aid performance test results need to be comprised in the personal hearing aid user information. Instead, only selected test results can be stored. As one example only test results indicating a malfunctioning or defect hearing aid component are included in the personal hearing aid user information.

A hearing aid performance test can be carried out in different ways e.g. it can be initiated automatically by the hearing aid, e.g. in response to a scheduled check, or it can be carried out in response to a hearing aid user trigger or it can be carried out in response to the hearing aid identifying a special situation that can indicate a defect or malfunctioning hearing aid component or some other issue that needs to be addressed. One example of such a special situation can be an open loop gain or an estimated vent size that exceeds above an upper threshold level or decreases below a lower threshold and as such may indicate that the hearing aid vent is plugged e.g. with ear wax or that an in the ear part of the hearing aid is not correctly positioned inside the ear of the user. In the present context the terminology “not correctly positioned inside the ear” can represent different situations including at least that:
an in the ear part of a hearing aid or a complete in-the-ear hearing aid (such as e.g. an ITE or CIC hearing aid) is positioned too deep into the ear canal or has progressed to far out from the ear canal, and
an in-the-ear part of a hearing aid has folded into some undesired shape such that the vent is more or less blocked or alternatively that the in-the-ear part of a hearing aid has folded into some other undesired shape wherein the “effective” vent size has increased significantly due to sound travelling around the in-the-ear part.

According to a second step 102 of the method, a novel or refurbished hearing aid is provided by a hearing aid repair facility.

As suggested by the name, a hearing aid repair facility has at least historically primarily been concerned with repairing a specific users specific hearing aid if it is defect or malfunctioning. However, repairing a (specific) hearing aid users (specific) hearing aid will generally be disadvantageous due to the duration the hearing aid user will need to be without the hearing aid that is to be repaired, which time for a major part is a result of the time it takes to transport the hearing aid to the hearing aid repair facility and back. Therefore, the present invention suggests a method where the hearing aid user when reporting or sending in a defect or malfunctioning hearing aid will receive another hearing aid instead of the original defect or malfunctioning hearing aid even if that hearing aid can in fact be repaired. Hereby the time spent on sending the defect or malfunctioning hearing aid back to the hearing aid repair facility (or maybe even first to a hearing care professional and therefrom to the hearing aid repair facility) will not impact the time the hearing aid user must be without a well-functioning hearing aid, because the hearing aid repair facility can start programming a replacement hearing aid for the hearing aid user right away.

Thus the hearing aid repair facility generally receives the defect or malfunctioning hearing aid for a specific user only after having programmed a replacement hearing aid for said specific user and subsequently shipped it back to said specific user.

Therefore, according to an embodiment, the hearing aid repair facility simply repairs the received hearing aid and store it for later use by another user.

However, independent on whether the received hearing aid can be repaired, the hearing aid repair facility diagnoses the hearing aid, and uploads the result to a cloud-based database service.

Hereby, statistics about the types of hearing aid defects (such as defect components) or malfunctioning experienced by at least one of: a specific user, users associated with a specific hearing care professional and a specific hearing aid type can be gathered over time and for a plurality of hearing aid users.

Obviously information related to how a specific hearing aid defect or malfunctioning has been repaired is likewise valuable to gather. As one example it can enable an evaluation of the relative success different repair approaches have and in response hereto suggest a specific approach for future repairs.

Thus generally having these data uploaded to a cloud-based database service, enable identification of specific issues that can then be addressed in various ways in order to minimize the risk of such issues going forward.

According to one embodiment the repair history of a specific hearing aid user can be compared to an average for all considered hearing aid users in order to identify e.g. hearing aid users that frequently need to have their receivers (i.e. loudspeakers) repaired, which may be an indication that the user tends to forget to replace ear wax guards with a reasonable frequency and consequently may benefit from at least one of: receiving a reminder to change the wax guards and receive personal training from the associated hearing care professional.

According to another embodiment the results of at least one of: automatic and hearing aid user initiated hearing aid diagnostics (such as microphone or loudspeaker error detection) are likewise uploaded periodically to the same cloud-based database service that comprises the repair data. Based hereon the cloud-based database service may be able to suggest where to begin when diagnosing a hearing aid that needs repair. Hereby repair time can be minimized.

According to a third step 103 of the method, said hearing aid repair facility is granted access to at least a part of a specific hearing aid user's data set (stored in the above mentioned cloud-based database service), wherein said part comprises the complete data image of a hearing aid setting for said specific hearing aid user.

According to an embodiment at least one of a hearing aid user and an associated hearing care professional is enabled to grant said hearing aid repair facility access to at least a part of the specific hearing aid user's data set such as said specific hearing aid user's complete data image of a hearing aid setting.

According to an embodiment at least one of the hearing aid user and an associated hearing care professional has obtained access rights to said cloud-based database service. Said access rights can be in the form of a unique username and secret password provided or enabled by the hearing aid manufacturer.

Typically, a hearing care professional will be authorized to grant a hearing aid repair facility access to a complete data image belonging to any specific hearing aid user that the hearing care professional is responsible for. While a specific hearing aid user obviously will only be authorized to grant access to his own complete data images.

According to an embodiment, both the specific hearing aid user and the hearing care professional need to agree before access is granted to the hearing aid repair facility.

Thus said hearing aid repair facility can be authenticated to access said cloud-based database service holding complete data images. Said authentication (i.e. access rights) can be in the form of a unique username and secret password provided or enabled by the hearing aid manufacturer.

However, authorization (for the hearing aid repair facility) to access a specific hearing aid users complete data image of a hearing aid setting requires further permission from at least one of the hearing aid user and the associated hearing care professional.

According to an embodiment said authorization is provided by using a security token. Thus the hearing aid repair facility (i.e. a person representing the hearing aid facility) is typically required to provide both their unique username and password, as well as a unique token code provided by the selected security token. This two-factor authentication process ensures that only the authorized hearing aid repair facility with the correct credentials (username and password) and the code provided by the security token can access a specific complete data image of a specific hearing aid user. Thus the unique token code adds an extra layer of security beyond just a username and password, making it more difficult for unauthorized users to gain access to a specific complete data image.

According to an embodiment the security token provides the unique token code in an email sent to the selected hearing aid repair facility.

According to an embodiment the unique token code is only valid for one download of the specific complete data image or is only valid for a limited duration or both.

According to an embodiment said step of granting said hearing aid repair facility access to at least a part of a specific hearing aid user's data set comprises the further steps of:
providing to the hearing aid repair facility a link to the cloud-based database service, and
authorizing the hearing aid repair facility to access said cloud-based database service and retrieve the data set of said specific hearing aid user.

According to a fourth step 104 of the method, said complete data image is used to provide a replacement hearing aid by transferring said complete data image of the hearing aid setting for the specific hearing aid user to said novel or refurbished hearing aid. In other words the complete data image of the hearing aid setting comprises all the necessary data required to make a copy of the hearing aid represented by the complete data image (of the hearing aid setting).

According to a fifth and final step 105 of the method said provided replacement hearing aid is delivered to the specific hearing aid users residence address or mailing address. According to one embodiment the residence address or mailing address of a specific hearing aid user is comprised in the data set that is stored in a cloud-based database service, that the hearing aid repair facility has been granted access to as explained above.

Alternatively, the hearing care professional or the specific hearing aid user can send the residence address or mailing address to the repair facility using basically any communication form but preferably an electronic communication form such as e-mail or some mobile phone based text messaging system.

According to an embodiment said method of repairing a hearing aid comprises using various data stored in a cloud-based database service to train a neural network-based prediction model to predict the best possible repair approach, such as the best hearing aid component or hearing aid feature to diagnose first.

According to an embodiment said data stored in said cloud-based database service comprises three general groups of data: results of hearing aid performance tests, personal hearing aid user data and additional data.

In an embodiment said group comprising results of hearing aid performance tests are based on different types of hearing aid performance tests directed at detecting respectively: a defect or malfunctioning hearing aid component, ear wax clogging of a wax guard or a vent, and an in-the-ear part of the hearing aid not being correctly positioned inside the ear of the hearing aid user. In an embodiment said hearing aid performance test are initiated by the hearing aid user and/or the hearing aid is adapted to automatically carry out hearing performance tests with regular intervals and/or in response to some specific trigger event.

In an embodiment said group of personal hearing aid user data comprises: data identifying the specific hearing aid user, the age of the hearing aid user, the sex of the hearing aid user, hearing aid types worn by the hearing aid user, when and for how long each of said worn hearing aids has been worn by the hearing aid user, repair history for at least one of said worn hearing aids worn by the hearing aid user including whether and in the affirmative what type of hearing aid component defect or other type of malfunctioning was identified.

In an embodiment said group of additional data comprises: a hearing care professional responsible for the hearing aid user or the specific over-the-counter procedure used by the hearing aid user, a hearing aid repair facility having repaired a hearing aid worn by the hearing aid user.

In an alternative embodiment only two (or even only one) of said groups of data are used to train said neural network-based prediction model, but what is gained in terms of lesser complexity may of course be lost in prediction accuracy (i.e. the percentage of correct predictions).

In an embodiment only the performance tests directed at detecting a defect or malfunctioning hearing aid component is used to initially train the neural network-based prediction model and subsequently be used as input to the neural network-based prediction model. The reason being that this information, if positively detecting a defect or malfunctioning hearing component, obviously is important in the present context. Thus, according to an embodiment performance tests directed at detecting a defect or malfunctioning hearing aid component is only uploaded to the cloud-based database service if a positive detection of a defect or malfunctioning hearing aid component has been made.

In an embodiment only the personal hearing aid user data used to identify the specific hearing aid user is used to initially train the neural network-based prediction model and subsequently be used as input to the neural network-based prediction model. The reason being that different hearing aid user may have significantly different skills and habits when it comes to cleaning and maintaining a hearing aid and consequently this information can be important for the prediction accuracy.

In an embodiment only the additional data of the hearing care professional responsible for the hearing aid user or the specific over-the-counter procedure used by the hearing aid user is used to initially train the neural network-based prediction model and subsequently be used as input to the neural network-based prediction model. The reason for this is similar to what was explained for the specific hearing aid user, because the effectiveness of one hearing care professional or one over-the-counter procedure with respect to learning the hearing aid user to clean and maintain his/hers hearing aid may be significantly different and consequently this information can be important for the prediction accuracy.

However dependent on the specific circumstances, such as e.g. data privacy regulations, the above mentioned data can be combined in various ways different from the above mentioned examples.

In an embodiment a feedforward neural network, such as a multilayer perceptron neural network, is selected as the neural network architecture for said neural network prediction model. According to an embodiment a deep neural network is selected which generally will provide better performance with respect to learning complex hierarchical features and the ability to extract relevant features from the input data. However according to an alternative embodiment a non-deep neural network is selected whereby the requirements to computational resources can be relieved and furthermore non-deep neural networks are generally less prone to overfitting relatively small datasets.

However, in an embodiment the feedforward neural network is a deep neural network and comprises an input layer, at least two hidden layers and an output layer, wherein at least some of the layers and preferably the final layers are dense. The dense layers are especially advantageous for classification tasks and prediction tasks such as the present.

According to an embodiment at least the hidden layers of the feedforward neural network is using the Rectified Linear Unit activation function, in order to alleviate the vanishing gradient problem. According to one embodiment the Rectified Linear Unit activation function is also used for the output layer but according to an alternative embodiment a softmax activation function is used instead for the output layer.

According to an embodiment the output layer consists of a plurality of neurons corresponding to the number of different output results that the prediction model has been trained to predict.

As will readily be understood by the skilled person the selected dimensions of a neural network can vary dependent on e.g. the required precision and/or the acceptable power consumption.

In an embodiment binary cross-entropy is used as the loss function, when training the evaluation neural network.

Thus, as will be clear for the skilled person the dimensions and all the exact specific details of the neural network of the present application may vary in a number of different ways all of which will be obvious for the skilled person.

According to an embodiment said neural network-based prediction model to predict the best possible hearing aid repair approach is trained based on at least the following steps:
Obtaining, from said cloud-based database service, data representing input and corresponding output of the neural network-based prediction model whereby supervised learning of the neural network-based prediction model is enabled and wherein input feature vectors of said neural network-based prediction model comprises elements representing at least some of: said personal hearing aid user information, said additional data and said results of at least one type of hearing aid performance test and wherein said output of said neural network-based prediction model represents a specific hearing aid component defect or another type of malfunctioning detected as part of the procedure carried out at a hearing aid repair facility and uploaded to the cloud-based database service as part of the repair history (as discussed above).
splitting the input feature vectors and the corresponding output into a training set and a validation set and feeding the training set into said neural network-based prediction model and adjust the neural network weights based on backpropagation; and;
using the validation set to check the performance of said trained neural network-based prediction model in order to avoid overfitting.

According to another embodiment of the invention reference is now given to a hearing aid repair system comprising:
a cloud-based database service holding for each of a plurality of hearing aid users, a data set comprising a complete data image of a hearing aid setting;
a hearing aid repair facility computing system configured to:
   enable access to said data base and to retrieve a complete data image for a specific hearing aid user in response to a positive evaluation of access rights, and
   use said complete data image to program a replacement hearing aid.

According to yet another embodiment of the invention an alternative method of repairing a hearing aid is given by the itemized steps below:

1. A method of repairing a hearing aid comprising the steps of:
providing a cloud-based database service;
storing in said cloud-based database service, for each of a plurality of hearing aid users, a data set comprising:
   results of at least one type of hearing aid performance test, wherein said hearing aid performance test is initiated by the hearing aid user and/or the hearing aid is adapted to automatically carry out hearing performance tests with regular intervals and/or in response to some specific trigger event; and wherein said types of hearing aid performance tests are directed at detecting at least one of: a defect or malfunctioning hearing aid component, ear wax clogging of a wax guard or a vent, and an in-the-ear part of the hearing aid not being correctly positioned inside the ear of the hearing aid user;
   personal hearing aid user information comprising at least one of: data identifying the specific hearing aid user, the age of the hearing aid user, the sex of the hearing aid user, hearing aid types worn by the hearing aid user, when and for how long each of said worn hearing aids has been worn, repair history for at least one of said worn hearing aids including whether and in the affirmative what type of hearing aid component defect or other type of malfunctioning was identified; and
   additional data comprising at least one of: a hearing care professional responsible for the hearing aid user or the specific over-the-counter procedure used by the hearing aid user, a hearing aid repair facility having repaired a hearing aid worn by the hearing aid user;
using said data sets, from each of said plurality of hearing aid users, to train a neural network-based prediction model to predict the best possible repair approach, such as the best hearing aid component or hearing aid feature to diagnose first.

Wherein said step of training a neural network-based prediction model comprises the steps of:
obtaining, from said cloud-based database service, data representing input and corresponding output of the neural network-based prediction model whereby supervised learning of the neural network-based prediction model is enabled and wherein input feature vectors of said neural network-based prediction model comprises elements representing at least some of: said personal hearing aid user information, said additional data and said results of at least one type of hearing aid performance test;
wherein said output of said neural network-based prediction model represents a specific hearing aid component defect or another type of malfunctioning;
selecting a neural network architecture such as a feedforward neural network;
splitting the input feature vectors and the corresponding output into a training set and a validation set and feeding the training set into said neural network-based prediction model and adjust the neural network weights based on backpropagation and;
using the validation set to check the performance of said trained neural network-based prediction model in order to avoid overfitting.

1. A method of repairing a hearing aid comprising the steps of:
storing in a cloud-based database service, for each of a plurality of hearing aid users, a data set comprising a complete data image of a hearing aid setting;
providing in a hearing aid repair facility a novel or refurbished hearing aid;
granting said hearing aid repair facility access to at least a part of a specific hearing aid user's data set, wherein said part comprises the complete data image of a hearing aid setting for said specific hearing aid user;
providing a replacement hearing aid by transferring at least said complete data image of the hearing aid setting for the specific hearing aid user to said novel or refurbished hearing aid; and
delivering said replacement hearing aid from said hearing aid repair facility and to said specific hearing aid user's residence or mailing address.

2. The method according to claim 1, comprising the step of:
enabling at least one of a specific hearing aid user and a hearing care professional to grant said hearing aid repair facility access to said at least part of a specific hearing aid user's data set, wherein said part comprises the complete data image of a hearing aid setting for said specific hearing aid user.

3. The method according to claim 1, wherein said step of storing in a cloud-based database service, for each of a plurality of hearing aid users, a data set comprising a complete data image of a hearing aid setting is carried out as part of the initial hearing aid fitting or is carried out at some point in time after the initial hearing aid fitting at the hearing aid user's discretion.

4. The method according to claim 1, wherein said step of: granting said hearing aid repair facility access to at least a part of a specific hearing aid user's data set, wherein said part comprises the complete data image of a hearing aid setting for said specific hearing aid user comprises the further steps of:
providing to the hearing aid repair facility a link to the cloud-based database service, and
authorizing the hearing aid repair facility to access said cloud-based database service and retrieve the data set of said specific hearing aid user.

5. The method according to claim 1, comprising:
uploading, during normal hearing aid operation, the result of at least one type of hearing aid performance test to said cloud-based database service; wherein
said hearing aid performance test is initiated by the hearing aid user and/or the hearing aid is adapted to automatically carry out hearing performance tests with regular intervals and/or in response to some specific trigger event; and wherein said types of hearing aid performance tests are directed at detecting at least one of: a defect or malfunctioning hearing aid component, ear wax clogging of a wax guard or a vent, and an in-the-ear part of the hearing aid not being correctly positioned inside the ear of the hearing aid user;
storing in said cloud-based database service
personal hearing aid user information comprising at least one of: data identifying the specific hearing aid user, the age of the hearing aid user, the sex of the hearing aid user, hearing aid types worn by the hearing aid user, when and for how long each of said worn hearing aids has been worn, repair history for at least one of said worn hearing aids including whether and in the affirmative what type of hearing aid component defect or other type of malfunctioning was identified; and
additional data comprising at least one of: a hearing care professional responsible for the hearing aid user or the specific over-the-counter procedure used by the hearing aid user, a hearing aid repair facility having repaired a hearing aid worn by the hearing aid user;
using said data sets, from each of said plurality of hearing aid users, to train a neural network-based prediction model to predict the best possible repair approach, such as the best hearing aid component or hearing aid feature to diagnose first; and
using said trained neural network-based prediction model to predict the best possible repair approach for a given specific hearing aid.

6. The method according to claim 5, wherein said step of training a neural network-based prediction model comprises the steps of:
obtaining, from said cloud-based database service, data representing input and corresponding output of the neural network-based prediction model whereby supervised learning of the neural network-based prediction model is enabled and wherein input feature vectors of said neural network-based prediction model comprises elements representing at least some of: said personal hearing aid user information, said additional data and said results of at least one type of hearing aid performance test;
wherein said output of said neural network-based prediction model represents a specific hearing aid component defect or another type of malfunctioning;
selecting a neural network architecture such as a feedforward neural network;
splitting the input feature vectors and the corresponding output into a training set and a validation set and feeding the training set into said neural network-based prediction model and adjust the neural network weights based on backpropagation and;
using the validation set to check the performance of said trained neural network-based prediction model in order to avoid overfitting.

7. The method according to claim 1, comprising:
evaluating statistically at least some of said uploaded data to said cloud-based database service in order to enable identification of specific issues related to at least one of a specific hearing aid user, a specific hearing care professional, a specific type of hearing aid, a specific hearing aid component and a specific repair process.

8. The method according to claim 1, wherein the step of delivering said replacement hearing aid to said specific hearing aid user's residence or mailing address comprises the further steps of:
delivering a return box to said specific hearing aid user's residence or mailing address together with the replacement hearing aid, wherein said return box is prepared to enable a malfunctioning hearing aid to be returned to a hearing aid repair facility; wherein
said return box comprises a questionnaire directed at determining why the malfunctioning hearing aid is returned, wherein information gathered from said questionnaire is stored in the data set of said specific user, and wherein
this information will be available to facilitate a subsequent repairing of a hearing aid belonging to said specific hearing aid user by enabling the hearing aid repair facility to see the repair history of the specific hearing aid user when granted access to at least said part of the specific hearing aid user's data set.

9. A hearing aid repair system comprising:
a cloud-based database service holding for each of a plurality of hearing aid users, a data set comprising a complete data image of a hearing aid setting;
a hearing aid repair facility computing system configured to:
enable access to said cloud-based database service and to retrieve a complete data image for a specific hearing aid user in response to a positive evaluation of access rights, and
use said complete data image to program a replacement hearing aid.

10. The hearing aid repair system according to claim 9, further comprising a neural network-based prediction model trained to predict the best possible repair approach, such as the best hearing aid component or hearing aid feature to diagnose first.
